(19) United States
(12) Patent Application Publication
(10) Pub. No.: US 2026/0188018 A1
(43) Pub. Date: Jul. 2, 2026

(54) DISTRIBUTED OPTICAL FIBER SENSING (DFOS) SYSTEM AND METHOD OF USING THE SAME

(71) Applicant: NEC Corporation, Tokyo (JP)

(72) Inventors: Hemant Shivsagar PRASAD, Tokyo (JP); Yoshiyuki YAJIMA, Tokyo (JP); Daisuke IKEFUJI, Tokyo (JP); Tomoyuki HINO, Tokyo (JP)

(21) Appl. No.: 19/002,559

(22) Filed: Dec. 26, 2024

(51) Int. Cl. G06V 20/54; G01H 9/00; G08G 1/04

(52) U.S. Cl. CPC G06V 20/54; G01H 9/002; G01H 9/004; G06V 2201/08; G08G 1/04

(57) ABSTRACT

A traffic monitoring system includes a distributed acoustic sensor (DAS) connected to an optical fiber, wherein the DAS is configured to generate distributed optical fiber sensing (DFOS) data. The traffic monitoring system further includes a traffic monitoring apparatus. The traffic monitoring apparatus is configured to receive the DFOS data; receive camera data captured by a camera, wherein the camera has a camera capture range; calibrate the DFOS data using the camera data; and monitor traffic outside of the camera capture range using the calibrated DFOS data.

### BACKGROUND

Optical fibers are present along numerous roadways. Distributed acoustic sensors (DASs) attached to these optical fibers are able to detect vibrations where the optical fibers are located. In some instances, these vibrations are the result of passing vehicles. DASs are able to collect data related to a number of vehicles, lane location of vehicles and vehicle speed.

DASs generate data based on time and distance in order to determine traffic parameters. An ability of DASs to detect individual vehicles is related to an amount of noise in a signal detected by the DAS.

### SUMMARY

Aspects of this description relate to a traffic monitoring system includes a distributed acoustic sensor (DAS) connected to an optical fiber, wherein the DAS is configured to generate distributed optical fiber sensing (DFOS) data. The traffic monitoring system further includes a traffic monitoring apparatus. The traffic monitoring apparatus is configured to receive the DFOS data; receive camera data captured by a camera, wherein the camera has a camera capture range; calibrate the DFOS data using the camera data; and monitor traffic outside of the camera capture range using the calibrated DFOS data.

Aspects of this description relate to a traffic monitoring method includes receiving distributed optical fiber sensing (DFOS) data captured by a distributed acoustic sensor (DAS) connected to an optical fiber. The traffic monitoring method further includes receiving camera data captured by a camera, wherein the camera has a camera capture range. The traffic monitoring method further includes calibrating the DFOS data using the camera data. The traffic monitoring method further includes monitoring traffic outside of the camera capture range using the calibrated DFOS data.

Aspects of this description relate to a non-transitory computer readable medium containing instructions for causing a traffic monitoring apparatus to execute operations comprising receiving distributed optical fiber sensing (DFOS) data captured by a distributed acoustic sensor (DAS) connected to an optical fiber. The operations further include receiving camera data captured by a camera, wherein the camera has a camera capture range. The operations further include calibrating the DFOS data using the camera data. The operations further include monitoring traffic outside of the camera capture range using the calibrated DFOS data.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic view of a distributed acoustic sensor (DAS) system along a roadway in accordance with some embodiments.

FIG. 2 is a diagram correlating camera data and distributed optical fiber sensing (DFOS) data in accordance with some embodiments.

FIG. 3 is a diagram correlating camera data and DFOS data in accordance with some embodiments.

FIG. 4 is a diagram correlating camera data and DFOS data in accordance with some embodiments.

FIG. 5 is a flow chart of a method of utilizing camera data and DFOS data in accordance with some embodiments.

FIG. 6 is a flow chart of a method of utilizing camera data and DFOS data in accordance with some embodiments.

FIG. 7 is a block diagram of a system for utilizing camera data and DFOS data in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Utilizing data from optical fibers along roadways is useful for determining traffic volume, traffic speed, accidents and other events along roadways. In order to increase usefulness of traffic information obtained based on data from optical fibers, precise locations along the roadways corresponding to the traffic information are determined. Since optical fibers are not always installed precisely parallel to roadways, merely determining a distance along the optical fiber that corresponds to the received traffic information does not provide sufficient precision, in some instances. Identification of fixed reference points, such as bridges, along a roadway helps to improve precision by permitting correlation of a known geographic location with a distance along the optical fiber. Utilizing these fixed reference points improves location precision of traffic information. In some instances, fixed reference points include known location of traffic cameras for capturing images of roadways.

In addition to determining locations of fixed reference points along the optical fiber, identifying locations of extra optical fiber helps to improve location precision for traffic information. Optical fibers installed along roadways often have extra sections of optical fiber, such as loops of optical fiber, to provide extra optical fiber to assist with repair or relocation of the installed optical fiber. Accounting for the extra portions of the optical fiber, e.g., optical fiber loops, helps to improve location precision by accounting for the differences in optical fiber length and roadway length introduced by such extra portions of the optical fiber. By correlating camera data with distributed optical fiber sensing (DFOS) data, a greater degree of location precision is obtained. This increase in location precision improves accuracy of determining of traffic conditions or traffic events, such as accidents or congestion, in locations where traffic cameras are not present or not functioning.

Improvements in precision of the location of traffic information further help with city planning by determining, for example, which locations along a roadway are choke points for traffic, where do traffic accidents more frequently occur, and how traffic patterns shift within a roadway system. This information helps with the planning of improvement of existing roadways or construction of new roadways.

Additionally, precision location of traffic information assists with navigation of a vehicle traveling along the roadway. By providing drivers with more accurate traffic data, navigation systems and/or navigation applications become more useful to the drivers. Increased precision navigation is also useful for autonomous driver or driver assist functionalities for vehicles. Determining precisely where traffic congestion or a traffic accident has occurred, an autonomous driving vehicle or driver assist system is able to direct a vehicle along a more efficient path.

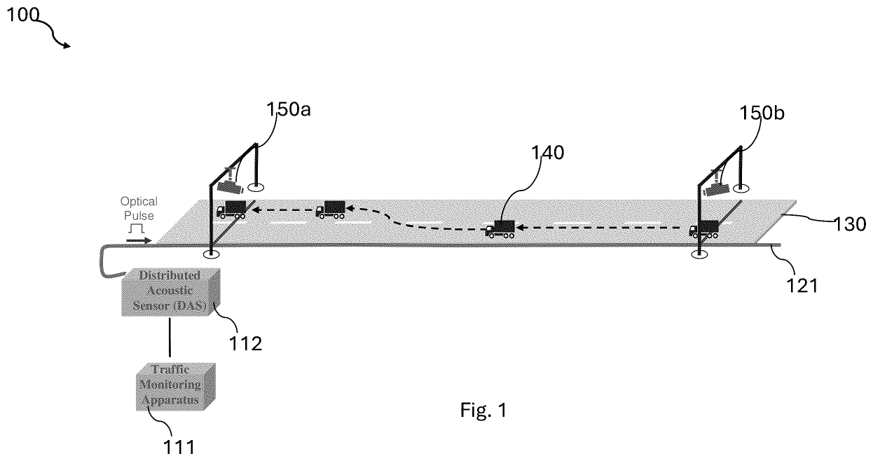

FIG. 1 is a schematic view of a distributed acoustic sensor (DAS) system 100 along a roadway 130 in accordance with some embodiments. DAS system 100 includes a traffic monitoring apparatus 111 in communication with a DAS 112. DAS system 100 further includes an optical fiber 121 connected to DAS 112. Optical fiber 121 is along roadway 130. Roadway 130 includes two lanes. A single vehicle 140 is on roadway 130. One of ordinary skill in the art would understand that additional vehicles are on the roadway 130 in some instances. Use of data for multiple vehicles is discussed in more detail below. Some vehicles on roadway 130 are larger than other vehicles on roadway 130. While the description refers to an optical fiber 121, one of ordinary skill in the art would understand that the optical fiber 121 includes a multi-fiber bundle in some embodiments. The DAS system 100 further includes a first traffic camera 150a and a second traffic camera 150b, collectively called traffic cameras 150.

As vehicle 140 passes along roadway 130 the vehicle 140 generates vibrations. These vibrations change a manner in which light propagates along optical fiber 121. DAS 112 is connected to optical fiber 121 and sends an optical signal down optical fiber 121 and detects the returned light from optical fiber 121. The resulting data is called waterfall data. The waterfall data provides information related to a number of vehicles, directionality of travel by the vehicles, vehicle speed and lane location of the vehicles on roadway 130.

Roadway 130 in FIG. 1 is on solid ground. Solid ground does not vibrate at a sufficiently high amplitude to obscure detection of vehicle 140 traveling along roadway 130. As a result, DAS 112 is able to accurately detect vehicle 140 traveling along roadway 130. In some embodiments, roadway 130 includes at least a bridge or a small vehicle.

Unlike solid ground, bridges exhibit different vibration characteristics, such as dampening. The vibration characteristics of bridges are impacted by bridge length, construction material of the bridge, wind and other factors. These differences in vibration characteristics of bridges are able to be utilized to determine where along the optical fiber 121 bridges are located. Small vehicles, such as small cars or motorcycles, also produce less vibration, which have less impact on propagation of the optical signal in the optical fiber 121. As a result, the DFOS data collected by the DAS has more difficulty detecting smaller vehicles.

The traffic cameras 150 capture images of the roadway 130 including a location of the vehicle 140 along the roadway 130. In some embodiments, the traffic cameras 150 capture still images. In some embodiments, the traffic cameras 150 capture video images. In some embodiments, the traffic cameras 150 capture images using visible light. In some embodiments, the traffic cameras 150 capture images using non-visible light, such as infrared light. The traffic cameras 150 capture camera data that is usable to identify a location of the vehicle 140 on the roadway. The location of the vehicle 140 includes both a distance from each of the first traffic camera 150a and the second traffic camera 150b as well as a lane of the roadway 130 in which the vehicle 140 is travelling. In some instances, the traffic cameras 150 also capture camera data indicating a lane change by the vehicle 140 and a location along the roadway 130 where the lane change occurred.

In some embodiments, the camera data is usable to identify or classify the vehicle 140. Classifying the vehicle 140 includes determining a type of the vehicle 140. A type of the vehicle is determined based on a size of the vehicle 140, a number of axles of the vehicle 140, identifiable markings on the vehicle 140, or other suitable criteria. Identifying the vehicle 140 includes determining a specific identification of the vehicle 140. In some embodiments, identifying the vehicle is performed using camera data that captures a license plate of the vehicle 140. In some embodiments, the identifying of the vehicle is performed using other identifying information, such as a radio frequency identification (RFID) tag, attached to the vehicle 140.

The camera data from the traffic cameras 150 is correlated with the DFOS data from the DAS 112 in order to increase the precision of the DFOS data. As noted above, extra sections of the optical fiber 121, such as loops, decreases precision of the DFOS data. Also, smaller vehicles have reduced vibrations which potentially cause DFOS data associated with such a small vehicle to be lost in extraneous noise within the DFOS data. By correlating the camera data with the DFOS data, deviations within the DFOS data are identified and the precision of the DFOS data is improved. Improvement of the DFOS data precision helps with traffic monitoring in locations where traffic camera 150 are not present.

In numerous situations, traffic cameras 150 are located along highly traveled sections of the roadway 130, while less traveled sections of the roadway 130 do not include traffic cameras 150. If an abnormality, such as a traffic accident or traffic congestion occurs in a section of the roadway 130 where traffic cameras 150 are absent, then the only way to identify the existence of the abnormality by reports from other vehicles or if the abnormality causes traffic to back up into a section of the roadway 130 that is monitored by the traffic cameras 150. Placement of optical fiber 121 along the roadway 130, including along lesser traveled sections of the roadway 130, is less expense and often is part of Internet connectivity installations. Increasing the precision of the DFOS data using the traffic cameras 150 where available, allows for use of the DFOS data in identifying traffic abnormalities in locations where the traffic cameras are not available. Thus, more comprehensive and accurate traffic monitoring along the roadway 130 is possible through the combined use of DFOS data that is calibrated using the camera data from traffic cameras 150.

The following description focuses on performed correlation between DFOS data and camera data for a single camera capture range. One of ordinary skill in the art would understand that this description is not limited to a single camera capture range and that calibrating the DFOS data at more camera capture ranges along the roadway 130 will provide further improvements to precision of the DFOS data in locations where the traffic cameras 150 are not available.

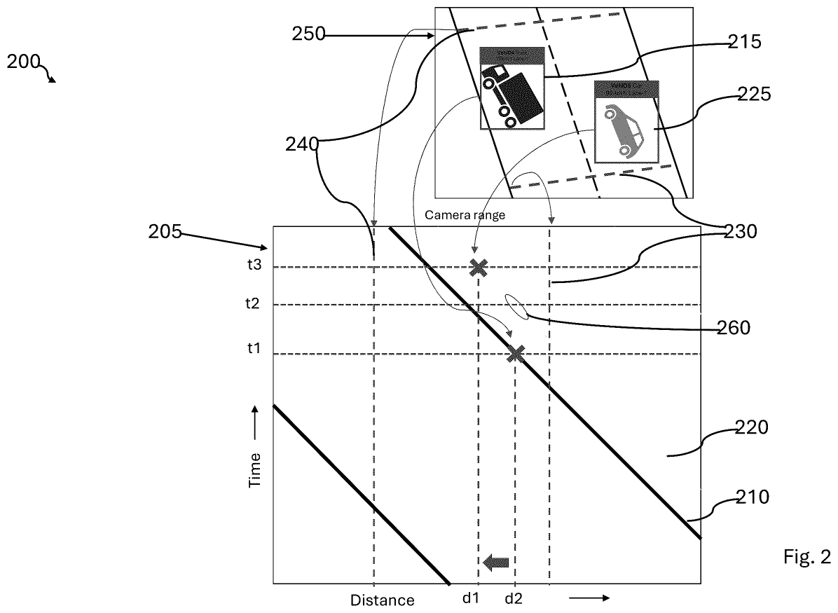

FIG. 2 is a diagram 200 correlating camera data 250 and distributed optical fiber sensing (DFOS) data 205 in accordance with some embodiments. The DFOS data 205 includes a simplified graph for time and distance. The time is based on a timer in the DAS, e.g., DAS 112 (FIG. 1), that captures the DFOS data. The distance is based on a distance that the detected vibration occurs from the DAS, e.g., DAS 112 (FIG. 1). Since the distance includes both a length along the optical fiber as well as a distance from the fiber, complex traffic patterns, such as lane changes, are more difficult to identify from DFOS data 205 in isolation. The DFOS data 205 is in a simplified graph that includes only identified tracks of vehicles. Raw waterfall data captured by the DAS, e.g., DAS 112 (FIG. 1), has more noise in the DFOS data. The simplified graph in FIG. 2 omits the noise for clarity and ease of understanding.

The DFOS data 205 includes a first track 210 for a first vehicle and a second track 220 for a second vehicle. A weight of the first track 210 is heavier than a weight of the second track 220. This indicates that the first vehicle creates more vibration than the second vehicle. Thus, the first vehicle is likely larger than the second vehicle. For example, in some instances, the first vehicle is a truck including more than two axels and the second vehicle is a commuter automobile. The slope of the first track 210 and the second track 220 indicate that the two vehicles are moving at a similar speed because the first track 210 and the second track 220 are roughly parallel. The first track 210 and the second track 220 also indicate that the vehicles are moving in a direction toward the DAS because as the time increases the distance decreases.

The camera data 250 includes an image including a first vehicle 215 and a second vehicle 225. The camera data 250 is correlated to the DFOS data 205 to match the first vehicle 215 to the first track 210 and the second vehicle 225 to the second track 220. The correlation between the camera data 250 and the DFOS data 205 is also usable to identify a first boundary 230 of a camera capture range and a second boundary 240 of the camera capture range. The camera capture range corresponds to a section of the roadway, e.g., roadway 130 (FIG. 1), that is captured by traffic cameras, e.g., traffic cameras 150 (FIG. 1). The location of the first boundary 230 and the second boundary 240 is based on a known location of the traffic cameras along the roadway.

The camera data 250 further includes a bounding box around the first vehicle 215 and a bounding box around the second vehicle 225. The bounding boxes are useful for classifying the first vehicle 215 and the second vehicle 225. For example, a larger bounding box indicates a larger vehicle relative to a smaller bounding box. The bounding boxes are also usable if the camera data 250 is subjected to further analysis, such as vehicle identification processes, to reduce the amount of data examined during the further analysis.

During a correlation between the camera data 250 and the DFOS data 205, reliability of both types of data is determined to assist with the correlation and tracking of vehicles along the roadway. Reliability of the camera data 250 is based on visibility for the traffic cameras and distance from the traffic cameras to the vehicles. For example, environmental conditions, such as fog or rain, could reduce visibility of a traffic camera, which would reduce a reliability score for the camera data 250. In addition, as the distance from the traffic camera to the vehicle increases, then a risk of error in applying the bounding box for the vehicle increases, resulting in a reduction in reliability score for the camera data 250.

Reliability of the DFOS data 205 is based on various trajectory features such as intensity, thickness or spread of the vehicle vibration indicated by the track. For example, the first track 210 has a higher reliability score than the second track 220 due to the weight of the first track 210. The lower reliability score for the second track 220 is due to an increased risk of the second track 220 being undiscernible from noise within the DFOS data 205. An example of an inability to discern the second track 220 from background noise is at location 260 in the DFOS data 205. At the location 260, the second track 220 is discontinuous because the detected vibrations of the second vehicle 225 are not discernable from background noise. The location 260 is at a distance d2 from the DAS at a time t2.

In order to improve tracking of the second vehicle 225, the DFOS data 205 is correlated with the camera data 250. Using the camera data 250, a determination is made that the second vehicle 225 is at distance d1 from the DAS at a time t3. This determination facilitates matching the travel pattern of the second vehicle 225 of the camera data 250 to the second track 220 of the DFOS data 205. Further, identification of the second vehicle 225 at location where the vehicle crosses the first boundary 230 of the camera capture range also helps to correlate the second track 220 to the second vehicle 225.

Correlating the DFOS data 205 with the camera data 250 shows that the first vehicle 215 is at distance d2 from the DAS at a time t1. The DFOS data 205 also shows that the first track 210, which has a high reliability score, indicates that the first vehicle 215 is at a location other than location 260 at time t2. As a result, correlating the camera data 250 with the DFOS data 205 for the second vehicle allows a DAS system, e.g., DAS system 100 (FIG. 1), to determine the location of the second vehicle 225 at the location 260 where the DFOS data 205 is incomplete. Using the camera data 250 to track the movement of the first vehicle 215 and second vehicle 225 between the first boundary 230 and the second boundary 240 helps with validation of the DFOS data 205 for tracking of the vehicles outside of the camera capture range defined by the first boundary 230 and the second boundary 240.

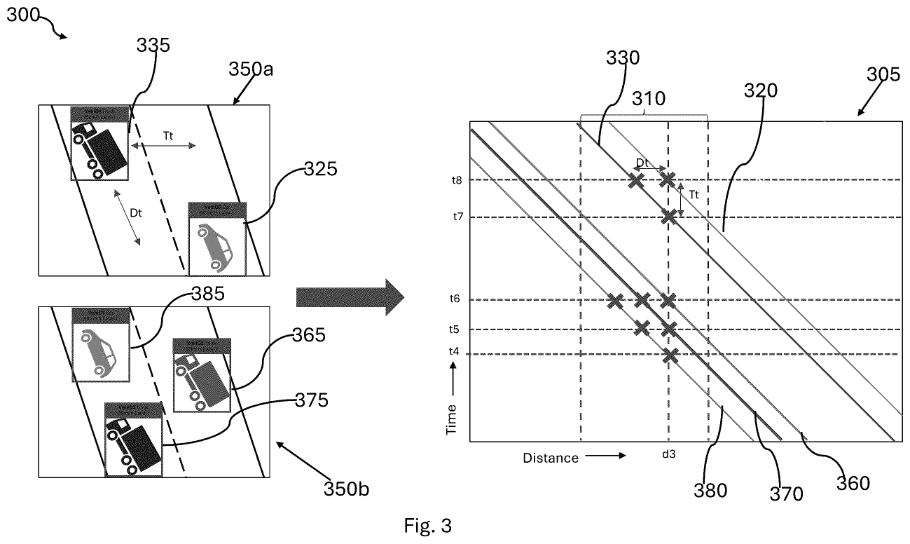

FIG. 3 is a diagram 300 correlating camera data 350a and 350b and DFOS data 305 in accordance with some embodiments. In some embodiments, the camera data 350a and 350b is similar to the camera data 250 (FIG. 2) and certain content of the camera data 350a and 350b is not described in detail for the sake of brevity. In some embodiments, the DFOS data 305 is similar to the DFOS data 205 (FIG. 2) and certain content of the DFOS data 305 is not discussed in detail for the sake of brevity. In comparison with the diagram 200 (FIG. 2), the diagram 300 includes two sets of camera data, first camera data 350a and second camera data 350b, collectively called camera data 350. Both sets of camera data 350 capture a same camera capture range 310. The diagram 300 helps to explain how to implement correlation between the camera data 350 and the DFOS data 305 in a high vehicle density scenario. Correlating the camera data 350 with the DFOS data 305 in a high vehicle density scenario is implemented using a time threshold and a distance threshold, in some embodiments.

A time threshold is usable to determine a lag duration for a second vehicle to reach a same distance from the DAS, e.g., DAS 112 (FIG. 1), as a first vehicle. In some embodiments, the time threshold is a static value. In some embodiments, the time threshold is determined based on an average speed of one or all of the vehicles under examination. For example, as a speed of a vehicle increases and lag duration for the vehicle to reach a position is shorter. As a result, the time threshold is increased to in order to reduce a risk of incorrect pattern matching between the camera data 350 and the DFOS data 305. In some embodiments, the time threshold ranges from 1.5 seconds to 3 seconds.

A distance threshold is usable to determine a difference in position of multiple vehicles at a specific time. In some embodiments, the distance threshold is static. In some embodiments, the distance threshold is adjusted based on a number of lanes in a roadway, e.g., roadway 130 (FIG. 1). In some embodiments, as a number of lanes on the roadway increases, the distance threshold decreases. In some embodiments, the distance threshold ranges from about 1 meter to about 3 meters. In some embodiments, separate vehicle tracks within the DFOS data 305 are identified based on at least one of the distance threshold or the time threshold. In some embodiments, separate vehicle tracks within the DFOS data 305 are identified based on both the time threshold and the distance threshold.

The DFOS data 305 includes locations of boundaries for a camera capture range 310. The DFOS data 305 further includes a first track 320 corresponding to a first vehicle 325 of the first camera data 350a; and a second track 330 corresponding to a second vehicle 335 of the first camera data 350a. The DFOS data 305 further includes a third track 360 corresponding to a third vehicle 365 of the second camera data 350b; a fourth track 370 corresponding to a fourth vehicle 375 of the second camera data 350b; and a fifth track 380 corresponding to a fifth vehicle 385 of the second camera data 350b.

The DFOS data 305 includes a time threshold Tt between the first track 320 and the second track 330 at a distance d3. The time threshold Tt is also depicted on the first camera data 350a merely for illustrative purposes. The DFOS data 305 further includes a distance threshold Dt between the first track 320 and the second track 330 at a time t8. The distance threshold Dt is depicted on the first camera data 350a merely for illustrative purposes.

When tracking vehicles using the DFOS, using the time threshold or the distance threshold helps to differentiate between individual vehicles for vehicle track purposes. If the vehicles are close together in time or position, then the precision of the vehicle tracking is reduced. By correlating the camera data 350 with the DFOS data 305, the vehicles detected at certain times or locations by the DFOS data 305 are able to be corroborated by the camera data 350. This corroboration helps to improve the precision of vehicle tracking using the DFOS data 305 outside of the camera capture range 310. For example, by corroborating, using the camera data 350, the position of the second vehicle 335 at time t7 and at time t8 detected by the DFOS data 305, tracking of the second vehicle outside of the camera capture range 310 is possible because the second track 330 is determined as corresponding to the second vehicle 335.

Applying the time threshold and the distance threshold to the DFOS data 305, the third track 360, the fourth track 370 and the fifth track 380 are identified within the DFOS data. Correlating the DFOS data 305 with the second camera data 350b corroborates the location of the third vehicle 365, the fourth vehicle 375 and the fifth vehicle 385 to the positions and times detected by the DFOS data 305. As a result, the DFOS data 305 is able to track the third vehicle 365, the fourth vehicle 375 and the fifth vehicle 385 outside of the camera capture range 310.

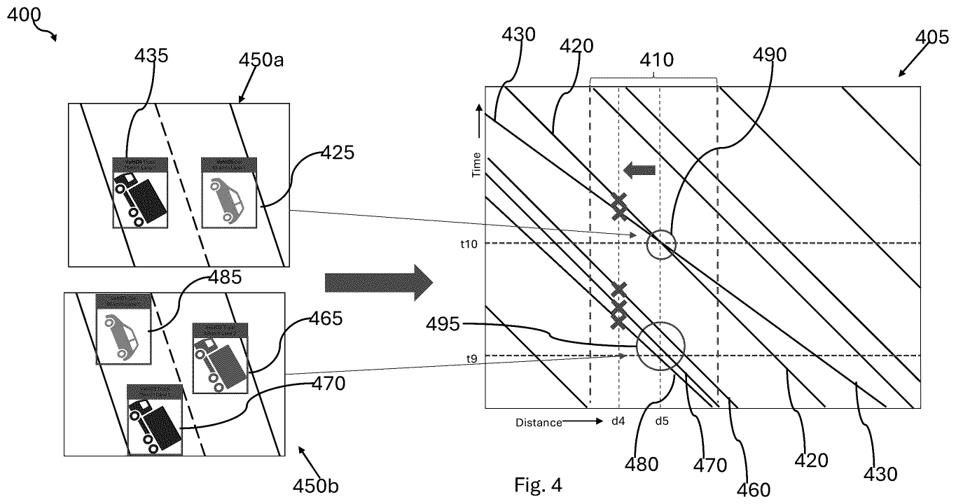

FIG. 4 is a diagram 400 correlating camera data 450a and 450b and DFOS data 405 in accordance with some embodiments. In some embodiments, the camera data 450a and 450b is similar to the camera data 250 (FIG. 2) and certain content of the camera data 450a and 450b is not described in detail for the sake of brevity. In some embodiments, the DFOS data 405 is similar to the DFOS data 205 (FIG. 2) and certain content of the DFOS data 405 is not discussed in detail for the sake of brevity. In comparison with the diagram 200 (FIG. 2), the diagram 300 includes two sets of camera data, first camera data 450a and second camera data 450b, collectively called camera data 450. Both sets of camera data 450 capture a same camera capture range 410. The diagram 400 helps to explain how to implement correlation between the camera data 450 and the DFOS data 405 in a high vehicle density scenario and a vehicle passing scenario.

The DFOS data 405 includes locations of boundaries for a camera capture range 410. The DFOS data 405 further includes a first track 420 corresponding to a first vehicle 425 of the first camera data 450a; and a second track 430 corresponding to a second vehicle 435 of the first camera data 450a. The DFOS data 405 further includes a third track 460 corresponding to a third vehicle 465 of the second camera data 450b; a fourth track 470 corresponding to a fourth vehicle 475 of the second camera data 450b; and a fifth track 480 corresponding to a fifth vehicle 485 of the second camera data 450b.

The DFOS data 405 further includes a first position 490 where the first track 420 and the second track 430 are too close together for separate identification and tracking. The first position 490 indicates a location where the first vehicle 425 passes the second vehicle 435. Due to the separation between the first track 420 and the second track 430 being less than each of a time threshold and a distance threshold, separate tracking of the first vehicle 425 and the second vehicle 435 is not possible at the distance d5. The first track 420 is capable of being distinguished from the second track 430, by at least one of the time threshold or the distance threshold, at distance d4. In order to facilitate the assignment of the tracks in the DFOS data 405 at distance d4 to corresponding vehicles, the DFOS data 405 is correlated with the first camera data 450a. The DFOS data 405 is correlated with the first camera data 450a in a manner similar to that discussed above with respect to diagram 200 (FIG. 2). In some embodiments, the correlation further considers a slope of the first track 420 and a slope of the second track 430 at a time prior to the first position 490 as well as the slope of the unassigned tracks at a time after the first position 490. Matching the slopes of the various tracks in the DFOS data 405 helps to improve accuracy vehicle assignment to the tracks after the first position 490. Once the tracks of the DFOS data 405 are assigned to the corresponding vehicles, then the DFOS data 405 is usable to track the first vehicle 425 and the second vehicle 430 outside of the camera capture range 410.

The DFOS data 405 further includes a second position 495 where the third track 460, the fourth track 470 and the fifth track 480 are too close together for separate identification and tracking. The second position 495 indicates a location where the third vehicle 465, the fourth vehicle 475 and the fifth vehicle 485 are close together, e.g., due to high traffic flow density. Due to the separation between the third track 460, the fourth track 470 and the fifth track 480 being less than each of a time threshold and a distance threshold, separate tracking of the third vehicle 465, the fourth vehicle 475 and the fifth vehicle 485 is not possible at the distance d5. The third track 460, the fourth track 470 and the fifth track 480 are distinguishable from one another, by at least one of the time threshold or the distance threshold, at distance d4. In order to facilitate the assignment of the tracks in the DFOS data 405 at distance d4 to corresponding vehicles, the DFOS data 405 is correlated with the second camera data 450b. The DFOS data 405 is correlated with the second camera data 450b in a manner similar to that discussed above with respect to diagram 200 (FIG. 2). In some embodiments, the correlation further considers a slope of each of at least one of the third track 460, the fourth track 470 or the fifth track 480 at a time prior to the second position 495 as well as the slope of the unassigned tracks at a time after the second position 495. Matching the slopes of the various tracks in the DFOS data 405 helps to improve accuracy vehicle assignment to the tracks after the second position 495. Once the tracks of the DFOS data 405 are assigned to the corresponding vehicles, then the DFOS data 405 is usable to track the third vehicle 465, the fourth vehicle 475 and the fifth vehicle 485 outside of the camera capture range 410.

In situations where the DFOS data 405 becomes unable to precisely track vehicles, such as at the first position 490 or the second position 495, the DFOS data 405 is correlated with the camera data 450 for a time subsequent to the inability to precisely track vehicles where separate vehicle tracking is possible. This correlation between the DFOS data 405 and the camera data 450 at the subsequent time helps to re-establish the assignment of tracks of the DFOS data 405 based on information available from the camera data 450. In comparison with other approaches, the correlation between the camera data 450 and the DFOS data 405 helps to improve the precision of tracking of vehicles outside of the camera capture range 410. This improved precision of vehicle tracking helps with traffic monitoring outside of the camera capture range 410.

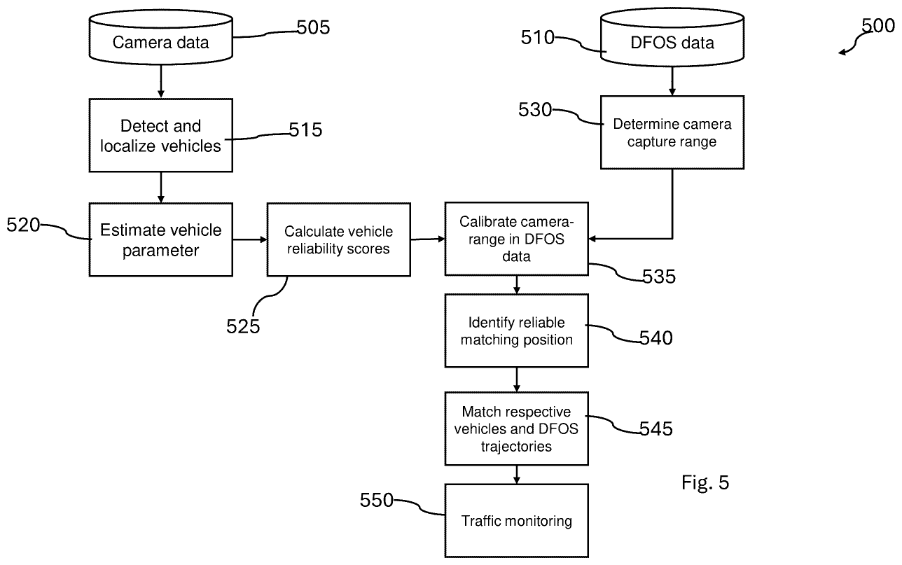

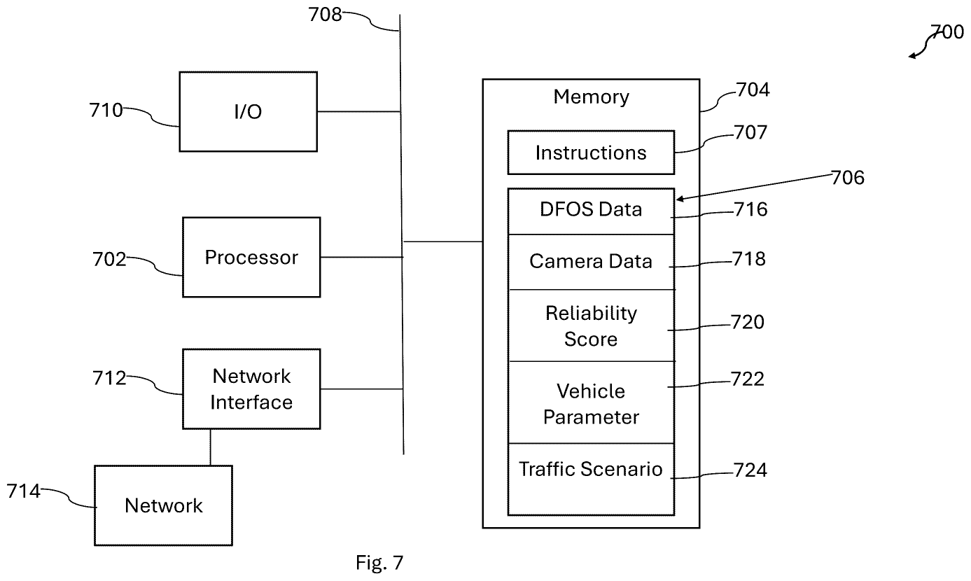

FIG. 5 is a flow chart of a method 500 of utilizing camera data and DFOS data in accordance with some embodiments. The method 500 is usable to utilize camera data and DFOS data for traffic monitoring. In some embodiments, the method 500 is usable to implement the functionality described with respect to the diagram 200 (FIG. 2), the diagram 300 (FIG. 3), or the diagram 400 (FIG. 4). In some embodiments, the method 500 is usable to implement functionality other than those described above. In some embodiments, the method 500 is implemented using the DAS system 100 (FIG. 1) or the system 700 (FIG. 7). In some embodiments, the method 500 is implemented using a system other than the DAS system 100 (FIG. 1) or the system 700 (FIG. 7).

In operation 505, camera data is received. The camera data includes images of a roadway including one or more vehicles traveling along the roadway. In some embodiments, the camera data is captured using traffic cameras 150 (FIG. 1). In some embodiments, the camera data is captured using cameras other than the traffic cameras 150 (FIG. 1). In some embodiments, the camera data includes camera data 250 (FIG. 2), camera data 350 (FIG. 3) or camera data 450 (FIG. 4). In some embodiments, the camera data is received via a wired connection. In some embodiments, the camera data is received wirelessly.

In operation 510, DFOS data is received. The DFOS data includes data indicating positions of vehicles along the roadway at different times. In some embodiments, the DFOS data is captured using DAS system 100 (FIG. 1). In some embodiments, the DFOS data is captured using a different system from the DAS system 100 (FIG. 1). In some embodiments, the DFOS data includes DFOS data 205 (FIG. 2), DFOS data 305 (FIG. 3) or DFOS data 405 (FIG. 4). In some embodiments, the DFOS data is received via a wired connection. In some embodiments, the DFOS data is received wirelessly.

In operation 515, vehicles are detected using the camera data. In some embodiments, the vehicles are detected using an object recognition algorithm applied to the camera data. In some embodiments, bounding boxes are arranged around detected vehicles to assist with differentiation between identified vehicles.

In operation 520, parameters of each vehicle are estimated. In some embodiments, the parameters include at least one of vehicle position along the roadway, a type of vehicle, a lane of travel of the vehicle, or an identity of the vehicle. In some embodiments, the position of the vehicle along the roadway is determined based on measured distances between the detected vehicle and known landmarks along the roadway, such as signs. In some embodiments, a type of vehicle is determined based on a number of axels of the detected vehicle. In some embodiments, a lane of travel of the vehicle is determined based on a measured distance between the vehicle and an edge of the roadway, or based on identification of lane markings along the roadway. In some embodiments, the identity of the vehicle is determined based on capturing of identifying information of the vehicle, such as a license plate or an RFID tag.

In operation 525, a reliability score of the vehicle based on the camera data is calculated. The reliability score of the vehicle indicates a confidence level in the accuracy of the vehicle parameters estimated in operation 520. The reliability score is impacted by environmental conditions, such as rain or fog, as well as distance between the traffic camera and the detected vehicle. In some embodiments, a size of the vehicle also impacts the reliability score with a larger vehicle having a higher reliability score. In some embodiments, the size of the vehicle is determined based on a size of the bounding box around the vehicle or a number of axels of the vehicle.

In operation 530, a camera capture range is determined. The camera capture range indicates an area of the received DFOS data that overlaps with a field of view for a traffic camera. In some embodiments, the camera capture range is determined based on an input from an operator. In some embodiments, the camera capture range is determined based on previous traffic monitoring iterations.

In operation 535, the DFOS data is calibrated based on the camera capture range. The DFOS data is calibrated by coordinating the determined boundaries of the camera capture range with distances from the DAS used to capture the DFOS data.

In operation 540, reliable matching positions are identified based on a correlation between the processed camera data and the DFOS data. The processed camera data includes the estimated vehicle parameters from operation 520. In some embodiments, the processed camera data further includes vehicle reliability scores. The reliable position matching is performed for specific distances and times within the DFOS data by correlating a vehicle detected in the camera data with a vibration source from the DFOS data. Based on the identified matching position, a track from the DFOS data passing through the matching position is assigned to a corresponding detected vehicle from the camera data. In some embodiments, details for identifying reliable matching positions are described above with respect to the diagram 200 (FIG. 2), the diagram 300 (FIG. 3) or the diagram 400 (FIG. 4).

In operation 545, the DFOS data is used to continue tracking a vehicle track both within the camera capture range as well as beyond the camera capture range. At positions within the camera capture range, the DFOS data is able to be corroborated by the camera data. At positions beyond the camera capture range, the DFOS data provides information about vehicle movement that is not able to be determined by the camera data.

In operation 550, traffic monitoring is performed. The traffic monitoring occurs both within the camera capture range as well as outside of the camera capture range. The traffic monitoring includes identification of traffic abnormalities, such as accidents or congestion, based on detected vibration of the DFOS data. A location of the traffic abnormality is able to be precisely determined using the DFOS data because location information for the DFOS data is calibrated based on the camera data. The traffic monitoring is usable to identify local authorities of traffic abnormalities, such as traffic accidents, in order to facilitate dispatching of emergency services. The traffic monitoring is also useful for planning future roadway developments, such as installing traffic signals or adjusting of a width of the roadway. By using the DFOS data to perform traffic monitoring, information is available that would not be available at all in systems that rely exclusively on camera data. In addition, the DFOS data is able to provide faster traffic monitoring outside of the camera capture range because the DFOS data is able to capture information about traffic abnormalities prior to traffic congestion backing up to a point within the camera capture range.

One of ordinary skill in the art would recognize that modifications to the method 500 are within the scope of this description. In some embodiments, at least one additional operation is included in the method 500. For example, in some embodiments, determining of a distance threshold or a time threshold for identifying tracks within the DFOS data is included. In some embodiments, at least one operation of the method 500 is omitted. For example, in some embodiments, the operation 525 is omitted from the method 500. In some embodiments, an order of operations within the method 500 is adjusted. For example, in some embodiments, the operation 525 occurs prior to the operation 520 to avoid processing time and load in attempting to estimate vehicle parameters in a situation where camera visibility is severely impacted by environmental conditions.

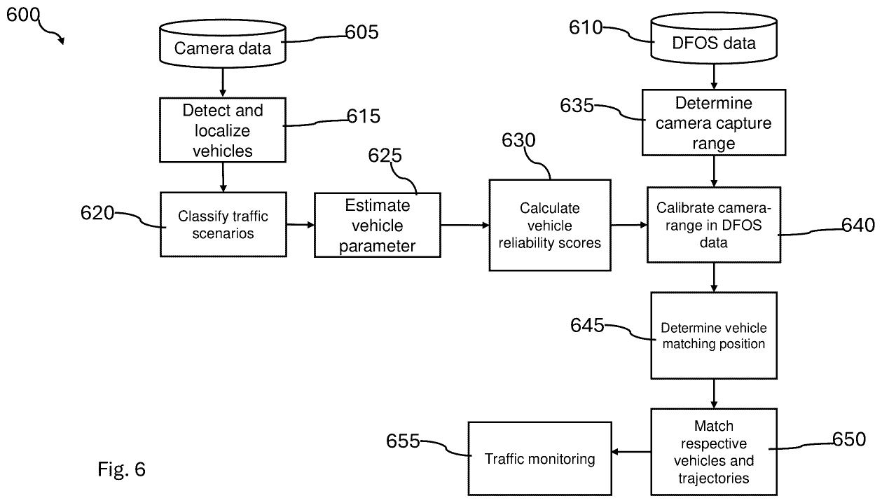

FIG. 6 is a flow chart of a method 600 of utilizing camera data and DFOS data in accordance with some embodiments. The method 600 is usable to utilize camera data and DFOS data for traffic monitoring. In some embodiments, the method 600 is usable to implement the functionality described with respect to the diagram 200 (FIG. 2), the diagram 300 (FIG. 3), or the diagram 400 (FIG. 4). In some embodiments, the method 600 is usable to implement functionality other than those described above. In some embodiments, the method 600 is implemented using the DAS system 100 (FIG. 1) or the system 700 (FIG. 7). In some embodiments, the method 600 is implemented using a system other than the DAS system 100 (FIG. 1) or the system 700 (FIG. 7). Some operations of the method 600 are similar to operations in the method 500 (FIG. 5) and the operations are not described in detail for the sake of brevity.

In operation 605, camera data is received. In some embodiments, the operation 605 is similar to the operation 505 (FIG. 5).

In operation 610, DFOS data is received. In some embodiments, the operation 610 is similar to the operation 510 (FIG. 5).

In operation 615, vehicles are detected using the camera data. In some embodiments, the operation 615 is similar to the operation 515 (FIG. 5).

In operation 620, traffic scenarios are classified. Traffic scenarios are classified based on whether the DFOS data is likely to be able to consistently track vehicles through the entire camera capture range. A traffic scenario is classified as complex if the DFOS data is unlikely to be able to consistently track a vehicle through the entire camera capture range. A traffic scenario is classified as simple if the DFOS data is likely to be able to consistently track a vehicle through the entire camera capture range. In some embodiments, a determination is made that the DFOS data is unlikely to be able to consistently track vehicles through the entire camera capture range in response to identifying a vehicle changing lanes, a vehicle passing another vehicle, or a high vehicle density within the camera capture range.

In operation 625, parameters of each vehicle are estimated. In some embodiments, the operation 625 is similar to the operation 520 (FIG. 5).

In operation 630, a reliability score of the vehicle based on the camera data is calculated. In some embodiments, the operation 630 is similar to the operation 525 (FIG. 5).

In operation 635, a camera capture range is determined. In some embodiments, the operation 635 is similar to the operation 530 (FIG. 5).

In operation 640, the DFOS data is calibrated based on the camera capture range. In some embodiments, the operation 640 is similar to the operation 535 (FIG. 5).

In operation 645, a vehicle matching position is determined. In response to operation 620 classifying the traffic scenario as simple, the operation 645 is similar to the operation 540 (FIG. 5). In response to operation 620 classifying the traffic scenario as complex, the vehicle matching position is set to a position where vehicles are separately identifiable in the DFOS data at a time subsequent to a situation where the DFOS data was unable to reliable identify separate vehicles. In some embodiments, the vehicle position matching for a complex traffic scenario is a manner similar to that described above with respect to diagram 400 (FIG. 4).

In operation 650, the DFOS data is used to continue tracking a vehicle track both within the camera capture range as well as beyond the camera capture range. In some embodiments, the operation 650 is similar to the operation 545 (FIG. 5).

In operation 655, traffic monitoring is performed. In some embodiments, the operation 655 is similar to the operation 550 (FIG. 5).

One of ordinary skill in the art would recognize that modifications to the method 600 are within the scope of this description. In some embodiments, at least one additional operation is included in the method 600. For example, in some embodiments, determining of a distance threshold or a time threshold for identifying tracks within the DFOS data is included. In some embodiments, at least one operation of the method 600 is omitted. For example, in some embodiments, the operation 630 is omitted from the method 600. In some embodiments, an order of operations within the method 600 is adjusted. For example, in some embodiments, the operation 630 occurs prior to the operation 625 to avoid processing time and load in attempting to estimate vehicle parameters in a situation where camera visibility is severely impacted by environmental conditions.

FIG. 7 is a block diagram of a system 700 for utilizing camera data and DFOS data in accordance with some embodiments. System 700 includes a hardware processor 702 and a non-transitory, computer readable storage medium 704 encoded with, i.e., storing, the computer program code 706, i.e., a set of executable instructions. Computer readable storage medium 704 is also encoded with instructions 707 for interfacing with external devices. The processor 702 is electrically coupled to the computer readable storage medium 704 via a bus 708. The processor 702 is also electrically coupled to an input/output (I/O) interface 710 by bus 1008. A network interface 712 is also electrically connected to the processor 702 via bus 708. Network interface 712 is connected to a network 714, so that processor 702 and computer readable storage medium 704 are capable of connecting to external elements via network 714. The processor 702 is configured to execute the computer program code 706 encoded in the computer readable storage medium 704 in order to cause system 700 to be usable for performing a portion or all of the operations as described with respect to the DAS system 100 (FIG. 1), the method 500 (FIG. 5) or the method 600 (FIG. 6), or another suitable system for utilizing camera data and DFOS data.

In some embodiments, the processor 702 is a central processing unit (CPU), a multi-processor, a distributed processing system, an application specific integrated circuit (ASIC), and/or a suitable processing unit.

In some embodiments, the computer readable storage medium 704 is an electronic, magnetic, optical, electromagnetic, infrared, and/or a semiconductor system (or apparatus or device). For example, the computer readable storage medium 704 includes a semiconductor or solid-state memory, a magnetic tape, a removable computer diskette, a random-access memory (RAM), a read-only memory (ROM), a rigid magnetic disk, and/or an optical disk. In some embodiments using optical disks, the computer readable storage medium 704 includes a compact disk-read only memory (CD-ROM), a compact disk-read/write (CD-R/W), and/or a digital video disc (DVD).

In some embodiments, the storage medium 704 stores the computer program code 706 configured to cause system 700 to perform a portion or all of the operations as described with respect to the DAS system 100 (FIG. 1), the method 500 (FIG. 5) or the method 600 (FIG. 6), or another suitable system for utilizing camera data and DFOS data. In some embodiments, the storage medium 704 also stores information used for performing a portion or all of the operations as described with respect to the DAS system 100 (FIG. 1), the method 500 (FIG. 5) or the method 600 (FIG. 6), or another suitable system for utilizing camera data and DFOS data as well as information generated during performing a portion or all of the operations as described with respect to the DAS system 100 (FIG. 1), the method 500 (FIG. 5) or the method 600 (FIG. 6), or another suitable system for utilizing camera data and DFOS data, such as a DFOS data parameter 716, a camera data parameter 718, a reliability score parameter 720, a vehicle parameter 722, a traffic scenario parameter 724 and/or a set of executable instructions to perform a portion or all of the operations as described with respect to the DAS system 100 (FIG. 1), the method 500 (FIG. 5) or the method 600 (FIG. 6), or another suitable system for utilizing camera data and DFOS data.

In some embodiments, the storage medium 704 stores instructions 707 for interfacing with external devices. The instructions 707 enable processor 702 to generate instructions readable by the external devices to effectively implement a portion or all of the operations as described with respect to the DAS system 100 (FIG. 1), the method 500 (FIG. 5) or the method 600 (FIG. 6), or another suitable system for utilizing camera data and DFOS data.

System 700 includes I/O interface 710. I/O interface 710 is coupled to external circuitry. In some embodiments, I/O interface 710 includes a keyboard, keypad, mouse, trackball, trackpad, and/or cursor direction keys for communicating information and commands to processor 702.

System 700 also includes network interface 712 coupled to the processor 702. Network interface 712 allows system 700 to communicate with network 714, to which one or more other computer systems are connected. Network interface 712 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described with respect to the DAS system 100 (FIG. 1), the method 500 (FIG. 5) or the method 600 (FIG. 6), or another suitable system for utilizing camera data and DFOS data is implemented in two or more systems 700, and information such as DFOS data, camera data, reliability score, vehicle parameters and traffic scenarios are exchanged between different systems 700 via network 714.

In some embodiments, the external devices use data from the DAS, e.g., the DAS 100 (FIG. 1), to determine at least one monitored traffic property within a region in a city or town. In some embodiments, the external devices use the at least one traffic property to determine whether a vehicle traveling along the roadway is over a weight limit for the roadway, e.g., based on a width and amplitude of the vibration line caused by the vehicle traversing the road. In some embodiments, the external devices use the at least one traffic property to develop a navigation plan for a GPS device. In some embodiments, the external devices use the at least one traffic property to assist with the routing of emergency vehicles. For example, by generating a navigation plan and/or for specifically identifying a location of a vehicle accident by detecting a large vibration amplitude. In some embodiments, the external devices use the at least one traffic pattern for detecting landslides based on extremely high vibration amplitudes and/or damage to the optical fiber.

In comparison with other approaches, the system 700 used to implement a portion or all of the operations as described with respect to the DAS system 100 (FIG. 1), the method 500 (FIG. 5) or the method 600 (FIG. 6), or another suitable system for utilizing camera data and DFOS data, is able to increase precision of determination of traffic abnormalities outside of a camera capture range. By using the optical fiber as the measuring instrument instead of visual monitoring devices, wireless communication is avoided. In some instances, wireless communication is interrupted or interferes with other wireless communication devices. Wireless communication also introduces more noise into the signal transmitted than the wired connection provided by the optical fiber. In addition, the system 700 is able to connect to optical fibers which have already been installed along roadways. This minimizes an amount of infrastructure used to install the system 700 and/or implement a portion or all of the operations as described with respect to the DAS system 100 (FIG. 1), the method 500 (FIG. 5) or the method 600 (FIG. 6), or another suitable system for utilizing camera data and DFOS data.

### Supplemental Note 1

A traffic monitoring system includes a distributed acoustic sensor (DAS) connected to an optical fiber, wherein the DAS is configured to generate distributed optical fiber sensing (DFOS) data. The traffic monitoring system further includes a traffic monitoring apparatus. The traffic monitoring apparatus is configured to receive the DFOS data; receive camera data captured by a camera, wherein the camera has a camera capture range; calibrate the DFOS data using the camera data; and monitor traffic outside of the camera capture range using the calibrated DFOS data.

### Supplemental Note 2

The traffic monitoring system according to Supplemental Note 1, wherein the traffic monitoring apparatus is configured to calibrate the DFOS data based on matching a position of a first vehicle track of the DFOS data and a first detected vehicle of the camera data.

### Supplemental Note 3

The traffic monitoring system according to Supplemental Note 1 or 2, the traffic monitoring apparatus is configured to match the position of the first vehicle track and the first detected vehicle based on a DFOS trajectory feature and a determined vehicle type of the first detected vehicle, wherein the DFOS trajectory feature includes at least one of intensity, thickness or spread of vibration indicate by the first vehicle track in the DFOS data.

### Supplemental Note 4

The traffic monitoring system according to any of Supplemental Notes 1-3, wherein the traffic monitoring apparatus is configured to match the position of the first vehicle track and the first detected vehicle in response to the first vehicle track being separate from all other vehicle tracks in the DFOS data by at least one of a time threshold or a distance threshold.

### Supplemental Note 5

The traffic monitoring system according to any of Supplemental Notes 1-4, wherein the traffic monitoring apparatus is configured to determine whether the first vehicle track is within a time threshold and a distance threshold of at least one other vehicle track in the DFOS data at a first time; and match the position of the first vehicle track and the first detected vehicle based on the DFOS data and the camera data at a second time subsequent to the first time in response to the first vehicle track being within the time threshold and the distance threshold of the at least one other vehicle track at the first time.

### Supplemental Note 6

The traffic monitoring system according to any of Supplemental Notes 1-5, wherein the traffic monitoring apparatus is configured to match the position of the first vehicle track and the first detected vehicle based on a slope of the first vehicle track at a third time prior to the first time in response to the first vehicle track being within the time threshold and the distance threshold of the at least one other vehicle track at the first time.

### Supplemental Note 7

The traffic monitoring system according to any of Supplemental Notes 1-6, wherein the traffic monitoring apparatus is configured to determine vehicle type for a first vehicle and a second vehicle based on the camera data; and correlate a first vehicle track of the DFOS data to the first vehicle and a second vehicle track of the DFOS data to a second vehicle based on the determined vehicle type of each of the first vehicle and the second vehicle.

### Supplemental Note 8

A traffic monitoring method includes receiving distributed optical fiber sensing (DFOS) data captured by a distributed acoustic sensor (DAS) connected to an optical fiber. The traffic monitoring method further includes receiving camera data captured by a camera, wherein the camera has a camera capture range. The traffic monitoring method further includes calibrating the DFOS data using the camera data. The traffic monitoring method further includes monitoring traffic outside of the camera capture range using the calibrated DFOS data.

### Supplemental Note 9

The traffic monitoring method according to Supplemental Note 8, wherein calibrating the DFOS data comprises matching a position of a first vehicle track of the DFOS data and a first detected vehicle of the camera data.

### Supplemental Note 10

The traffic monitoring method according to Supplemental Note 8 or 9, wherein matching the position of the first vehicle track and the first detected vehicle comprises matching the position of the first vehicle track and the first detected vehicle based on a DFOS trajectory feature and a determined vehicle type of the first detected vehicle, wherein the DFOS trajectory feature includes at least one of intensity, thickness or spread of vibration indicate by the first vehicle track in the DFOS data.

### Supplemental Note 11

The traffic monitoring method according to any of Supplemental Notes 8-10, wherein matching the position of the first vehicle track and the first detected vehicle in response to the first vehicle track being separate from all other vehicle tracks in the DFOS data by at least one of a time threshold or a distance threshold.

### Supplemental Note 12

The traffic monitoring method according to any of Supplemental Notes 8-11, further comprising determining whether the first vehicle track is within a time threshold and a distance threshold of at least one other vehicle track in the DFOS data at a first time; and matching the position of the first vehicle track and the first detected vehicle based on the DFOS data and the camera data at a second time subsequent to the first time in response to the first vehicle track being within the time threshold and the distance threshold of the at least one other vehicle track at the first time.

### Supplemental Note 13

The traffic monitoring method according to any of Supplemental Notes 8-12, wherein matching the position of the first vehicle track and the first detected vehicle comprises matching the position of the first vehicle track and the first detected vehicle based on a slope of the first vehicle track at a third time prior to the first time in response to the first vehicle track being within the time threshold and the distance threshold of the at least one other vehicle track at the first time.

### Supplemental Note 14

The traffic monitoring method according to any of Supplemental Notes 8-13, further comprising determining vehicle type for a first vehicle and a second vehicle based on the camera data; and correlating a first vehicle track of the DFOS data to the first vehicle and a second vehicle track of the DFOS data to a second vehicle based on the determined vehicle type of each of the first vehicle and the second vehicle.

### Supplemental Note 15

A non-transitory computer readable medium containing instructions for causing a traffic monitoring apparatus to execute operations comprising receiving distributed optical fiber sensing (DFOS) data captured by a distributed acoustic sensor (DAS) connected to an optical fiber. The operations further include receiving camera data captured by a camera, wherein the camera has a camera capture range. The operations further include calibrating the DFOS data using the camera data. The operations further include monitoring traffic outside of the camera capture range using the calibrated DFOS data.

### Supplemental Note 16

The non-transitory computer readable medium according to Supplemental Note 15, wherein the instructions cause the traffic monitoring apparatus to execute calibrating the DFOS data comprises matching a position of a first vehicle track of the DFOS data and a first detected vehicle of the camera data.

### Supplemental Note 17

The non-transitory computer readable medium according to Supplemental Note 15 or 16, wherein the instructions cause the traffic monitoring apparatus to execute matching the position of the first vehicle track and the first detected vehicle by matching the position of the first vehicle track and the first detected vehicle based on a DFOS trajectory feature and a determined vehicle type of the first detected vehicle, wherein the DFOS trajectory feature includes at least one of intensity, thickness or spread of vibration indicate by the first vehicle track in the DFOS data.

### Supplemental Note 18

The non-transitory computer readable medium according to any of Supplemental Notes 15-18, wherein the instructions cause the traffic monitoring apparatus to execute matching the position of the first vehicle track and the first detected vehicle in response to the first vehicle track being separate from all other vehicle tracks in the DFOS data by at least one of a time threshold or a distance threshold.

### Supplemental Note 19

The non-transitory computer readable medium according to any of Supplemental Notes 15-18, wherein the instructions cause the traffic monitoring apparatus to execute: determining whether the first vehicle track is within a time threshold and a distance threshold of at least one other vehicle track in the DFOS data at a first time; and matching the position of the first vehicle track and the first detected vehicle based on the DFOS data and the camera data at a second time subsequent to the first time in response to the first vehicle track being within the time threshold and the distance threshold of the at least one other vehicle track at the first time.

### Supplemental Note 20

The non-transitory computer readable medium according to any of Supplemental Notes 15-19, wherein the instructions cause the traffic monitoring apparatus to execute: determining vehicle type for a first vehicle and a second vehicle based on the camera data; and correlating a first vehicle track of the DFOS data to the first vehicle and a second vehicle track of the DFOS data to a second vehicle based on the determined vehicle type of each of the first vehicle and the second vehicle.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A traffic monitoring system comprising:
a distributed acoustic sensor (DAS) connected to an optical fiber, wherein the DAS is configured to generate distributed optical fiber sensing (DFOS) data;
a traffic monitoring apparatus, wherein the traffic monitoring apparatus is configured to:
receive the DFOS data;
receive camera data captured by a camera, wherein the camera has a camera capture range;
calibrate the DFOS data using the camera data; and
monitor traffic outside of the camera capture range using the calibrated DFOS data.

2. The traffic monitoring system according to claim 1, wherein the traffic monitoring apparatus is configured to calibrate the DFOS data based on matching a position of a first vehicle track of the DFOS data and a first detected vehicle of the camera data.

3. The traffic monitoring system according to claim 2, wherein the traffic monitoring apparatus is configured to match the position of the first vehicle track and the first detected vehicle based on a DFOS trajectory feature and a determined vehicle type of the first detected vehicle, wherein the DFOS trajectory feature includes at least one of intensity, thickness or spread of vibration indicate by the first vehicle track in the DFOS data.

4. The traffic monitoring system according to claim 2, wherein the traffic monitoring apparatus is configured to match the position of the first vehicle track and the first detected vehicle in response to the first vehicle track being separate from all other vehicle tracks in the DFOS data by at least one of a time threshold or a distance threshold.

5. The traffic monitoring system according to claim 4, wherein the traffic monitoring apparatus is configured to:
determine whether the first vehicle track is within a time threshold and a distance threshold of at least one other vehicle track in the DFOS data at a first time; and
match the position of the first vehicle track and the first detected vehicle based on the DFOS data and the camera data at a second time subsequent to the first time in response to the first vehicle track being within the time threshold and the distance threshold of the at least one other vehicle track at the first time.

6. The traffic monitoring system according to claim 5, wherein the traffic monitoring apparatus is configured to match the position of the first vehicle track and the first detected vehicle based on a slope of the first vehicle track at a third time prior to the first time in response to the first vehicle track being within the time threshold and the distance threshold of the at least one other vehicle track at the first time.

7. The traffic monitoring system according to claim 1, wherein the traffic monitoring apparatus is configured to:
determine vehicle type for a first vehicle and a second vehicle based on the camera data; and
correlate a first vehicle track of the DFOS data to the first vehicle and a second vehicle track of the DFOS data to a second vehicle based on the determined vehicle type of each of the first vehicle and the second vehicle.

8. A traffic monitoring method comprising:
receiving distributed optical fiber sensing (DFOS) data captured by a distributed acoustic sensor (DAS) connected to an optical fiber;
receiving camera data captured by a camera, wherein the camera has a camera capture range;
calibrating the DFOS data using the camera data; and
monitoring traffic outside of the camera capture range using the calibrated DFOS data.

9. The traffic monitoring method according to claim 8, wherein calibrating the DFOS data comprises matching a position of a first vehicle track of the DFOS data and a first detected vehicle of the camera data.

10. The traffic monitoring method according to claim 9, wherein matching the position of the first vehicle track and the first detected vehicle comprises matching the position of the first vehicle track and the first detected vehicle based on a DFOS trajectory feature and a determined vehicle type of the first detected vehicle, wherein the DFOS trajectory feature includes at least one of intensity, thickness or spread of vibration indicate by the first vehicle track in the DFOS data.

11. The traffic monitoring method according to claim 9, wherein matching the position of the first vehicle track and the first detected vehicle in response to the first vehicle track being separate from all other vehicle tracks in the DFOS data by at least one of a time threshold or a distance threshold.

12. The traffic monitoring method according to claim 11, further comprising
determining whether the first vehicle track is within a time threshold and a distance threshold of at least one other vehicle track in the DFOS data at a first time; and
matching the position of the first vehicle track and the first detected vehicle based on the DFOS data and the camera data at a second time subsequent to the first time in response to the first vehicle track being within the time threshold and the distance threshold of the at least one other vehicle track at the first time.

13. The traffic monitoring method according to claim 12, wherein matching the position of the first vehicle track and the first detected vehicle comprises matching the position of the first vehicle track and the first detected vehicle based on a slope of the first vehicle track at a third time prior to the first time in response to the first vehicle track being within the time threshold and the distance threshold of the at least one other vehicle track at the first time.

14. The traffic monitoring method according to claim 8, further comprising:
determining vehicle type for a first vehicle and a second vehicle based on the camera data; and
correlating a first vehicle track of the DFOS data to the first vehicle and a second vehicle track of the DFOS data to a second vehicle based on the determined vehicle type of each of the first vehicle and the second vehicle.

15. A non-transitory computer readable medium containing instructions for causing a traffic monitoring apparatus to execute operations comprising:
receiving distributed optical fiber sensing (DFOS) data captured by a distributed acoustic sensor (DAS) connected to an optical fiber;
receiving camera data captured by a camera, wherein the camera has a camera capture range;
calibrating the DFOS data using the camera data; and
monitoring traffic outside of the camera capture range using the calibrated DFOS data.

16. The non-transitory computer readable medium according to claim 15, wherein the instructions cause the traffic monitoring apparatus to execute calibrating the DFOS data comprises matching a position of a first vehicle track of the DFOS data and a first detected vehicle of the camera data.

17. The non-transitory computer readable medium according to claim 16, wherein the instructions cause the traffic monitoring apparatus to execute matching the position of the first vehicle track and the first detected vehicle by matching the position of the first vehicle track and the first detected vehicle based on a DFOS trajectory feature and a determined vehicle type of the first detected vehicle, wherein the DFOS trajectory feature includes at least one of intensity, thickness or spread of vibration indicate by the first vehicle track in the DFOS data.

18. The non-transitory computer readable medium according to claim 16, wherein the instructions cause the traffic monitoring apparatus to execute matching the position of the first vehicle track and the first detected vehicle in response to the first vehicle track being separate from all other vehicle tracks in the DFOS data by at least one of a time threshold or a distance threshold.

19. The non-transitory computer readable medium according to claim 15, wherein the instructions cause the traffic monitoring apparatus to execute:
determining whether the first vehicle track is within a time threshold and a distance threshold of at least one other vehicle track in the DFOS data at a first time; and
matching the position of the first vehicle track and the first detected vehicle based on the DFOS data and the camera data at a second time subsequent to the first time in response to the first vehicle track being within the time threshold and the distance threshold of the at least one other vehicle track at the first time.

20. The non-transitory computer readable medium according to claim 15, wherein the instructions cause the traffic monitoring apparatus to execute:
determining vehicle type for a first vehicle and a second vehicle based on the camera data; and
correlating a first vehicle track of the DFOS data to the first vehicle and a second vehicle track of the DFOS data to a second vehicle based on the determined vehicle type of each of the first vehicle and the second vehicle.
